(19) United States
(12) Patent Application Publication
(10) Pub. No.: US 2008/0151163 A1
(43) Pub. Date: Jun. 26, 2008

(54) OPTICAL COMPENSATION PANEL, METHOD FOR MANUFACTURING OPTICAL COMPENSATION PANEL AND LIQUID CRYSTAL DISPLAY

(75) Inventors: Toshinobu Sekiuchi, Kanagawa (JP); Kei Yonezawa, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/948,331

(22) Filed: Nov. 30, 2007

(30) Foreign Application Priority Data
Dec. 20, 2006 (JP) 2006-343236

(51) Int. Cl. G02F 1/1335; G02F 1/1333; B29D 11/00

(52) U.S. Cl. 349/117; 428/1.3; 430/4

(57) ABSTRACT

An optical compensation panel is disclosed. The optical compensation panel includes a first optical compensation layer, a second optical compensation layer and an adhesive layer for bonding the first optical compensation layer and the second optical compensation layer so as to face each other, wherein the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and the adhesive layer is formed so as to have a rate of change in glass transition temperature of the adhesive layer falling within 150% and a rate of change in weight of the adhesive layer falling within 5% before and after an annealing treatment.

### CROSS REFERENCES TO RELATED APPLICATIONS

The present invention contains subjects related to Japanese Patent Application JP 2006-343236 filed in the Japan Patent Office on Dec. 20, 2006, the entire contents of which being incorporated herein by reference.

### BACKGROUND OF THE INVENTION

1. Field of the Invention

The invention relates to an optical compensation panel, a method for manufacturing an optical compensation panel and a liquid crystal display device. In particular, the invention relates to an optical compensation panel having a first optical compensation layer, a second optical compensation layer and an adhesive layer for bonding the first optical compensation layer and the second optical compensation layer so as to face each other; a method for manufacturing the same; and a liquid crystal display device in which this optical compensation panel is disposed so as to face at a surface of a liquid crystal panel.

2. Description of the Related Art

A liquid crystal display device has a liquid crystal panel in which a liquid crystal layer is sealed between a pair of substrates. In the liquid crystal display device, the liquid crystal panel modulates light which has been irradiated from a liquid source, and displaying of an image is carried out by the modulated light. In comparison with CRT (cathode ray tube), such a liquid crystal display device has advantages such as slim type, lightweight and low electric power consumption. For that reason, the liquid crystal display device is used as a direct-view-type display device in electronic appliances such as personal computers, mobile phones and digital cameras and is also used as a projection-type display device such as projectors.

In the direct-view-type liquid crystal display device, the size of a display surface of the liquid crystal panel is a screen size as it is. For that reason, in performing displaying on a large-sized screen, in the direct-view-type liquid crystal display device, a large-sized liquid crystal panel is used. Alternatively, the display surface of an image is made large by coupling plural liquid crystal panels. Accordingly, in order to perform displaying on a large-sized screen in the direct-view-type liquid crystal display device, there is a possibility that the cost of the device becomes high.

On the other hand, in the projection-type liquid crystal display device, an image is displayed on a large-sized screen by irradiating a small-sized liquid crystal panel with light from a light source and enlarging and projecting the light which has transmitted through the liquid crystal panel by a lens. For that reason, in the projection-type liquid crystal display device, the device can be manufactured more cheaply than the direct-view-type liquid crystal display device.

This projection-type liquid crystal display device is roughly classified into a single-plate type and a three-plate type. In the single-plate type, the three primary colors are decomposed spatially or in terms of time by using one liquid crystal panel, thereby displaying an image on a screen. On the other hand, in the three-plate type, respective images of the three primary colors are displayed on three liquid crystal panels, respectively. Thereafter, the images of the three liquid crystal panels are combined into one image by using an optical system such as a prism, and the combined image is enlarged and projected, thereby displaying on a screen.

In such a liquid crystal display device, a TN mode is the mainstream. In the TN mode, since a pre-tilt component of a liquid crystal which is inclined at an angle of from 2 degrees to 8 degrees, there is a possibility that the contrast is reduced. Concretely, since the phase of a long-axis direction component of a liquid crystal molecule is delayed due to the anisotropy of a refractive index of the liquid crystal caused due to the pre-tilt component, incident light of linearly polarization becomes elliptical polarization due to the matter that a phase difference is generated between a slow-axis direction component and a fast-axis direction component by this liquid crystal molecule. Thus, there is a possibility that such a fault is generated.

For that reason, a reduction of the contrast of the image by the pre-tilt component is optically compensated by using an optical compensation panel, thereby realizing a high contrast.

The optical compensation panel is, for example, formed due to the matter that a pair of optical compensation layers are bonded by an adhesive layer. When these optical compensation layers compensate the phase difference, an image of the liquid crystal display device is displayed in a high contrast, and the image quality is enhanced (see, for example, JP-A-2006-184872, JP-A-2005-70771, JP-A-2004-245925 and JP-A-2004-46097). Here, for example, when a photopolymerization initiator photopolymerizes a photopolymerization material such as monomers upon irradiation with light, the adhesive layer is formed.

### SUMMARY OF THE INVENTION

However, in the case where the optical compensation panel becomes high in temperature, there is a possibility that separation is generated between respective layers configuring the optical compensation panel or a possibility that respective layers are deformed to generate photoelastic birefringence. Thus, there may be the case where optical compensation cannot be sufficiently realized, and displaying with high contrast cannot be achieved, resulting in a reduction of the image quality.

FIGS. 5A and 5B are each a view schematically showing the state that separation is generated between respective layers configuring an optical compensation panel, in which FIG. 5A shows the state before separation is generated, and FIG. 5B shows the state that layer-to-layer separation is generated.

As shown in FIG. 5A, when a photopolymerization initiator I photopolymerizes a photopolymerization material such as monomers upon irradiation with light, thereby forming an adhesive layer 41, the photopolymerization initiator I is taken into the adhesive layer 41 and remains among polymers P. For that reason, when exposed at a high temperature for a long period of time, as shown in FIG. 5B, the remaining photopolymerization initiator I vaporizes, and the weight and volume of the adhesive layer 41 decrease, whereby layer-to-layer separation is generated. Here, separation is generated between optical compensation layers 31 and 32 and oriented films 21 and 22 formed on substrates 11 and 12, respectively.

For that reason, when layer-to-layer separation is generated, there may be the case where optical compensation cannot be sufficiently realized, and displaying with high contrast cannot be achieved, resulting in a reduction of the image quality. In particular, in a projection-type liquid crystal display device, since the density of light to be irradiated on a liquid crystal panel is high, such a fault is actualized.

Accordingly, it is desirable to provide an optical compensation panel capable of displaying an image with high contrast, a method for manufacturing an optical compensation panel and a liquid crystal display device.

An optical compensation panel according to an embodiment of the invention is an optical compensation panel having a first optical compensation layer, a second optical compensation layer and an adhesive layer for bonding the first optical compensation layer and the second optical compensation layer so as to face each other, wherein the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and the adhesive layer is formed so as to have a rate of change in glass transition temperature of the adhesive layer falling within 150% and a rate of change in weight of the adhesive layer falling within 5% before and after an annealing treatment.

A method for manufacturing an optical compensation panel according to an embodiment of the invention is a method for manufacturing an optical compensation panel including the step of bonding a first optical compensation layer and a second optical compensation layer by an adhesive layer so as to face each other, wherein the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and the adhesive layer is formed so as to have a rate of change in glass transition temperature of the adhesive layer falling within 150% and a rate of change in weight of the adhesive layer falling within 5% before and after an annealing treatment.

The liquid crystal display device according to an embodiment of the invention is a liquid crystal display device including a liquid crystal panel having optical compensation panels disposed on a surface thereof to be irradiated with light so as to face each other, wherein the optical compensation panel has a first optical compensation layer, a second optical compensation layer and an adhesive layer for bonding the first optical compensation layer and the second optical compensation layer so as to face each other; and the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and the adhesive layer is formed so as to have a rate of change in glass transition temperature of the adhesive layer falling within 150% and a rate of change in weight of the adhesive layer falling within 5% before and after an annealing treatment.

According to embodiments of the invention, not only the adhesive layer is formed so as to contain the photopolymerization initiator in an amount of from 2 to 5% by weight relative to the photopolymerization material, but the adhesive layer is formed so as to have a rate of change in glass transition temperature of the adhesive layer falling within 150% and a rate of change in weight of the adhesive layer falling within 5% before and after an annealing treatment.

According to embodiments of the invention, an optical compensation panel capable of displaying an image with high contrast, a method for manufacturing an optical compensation panel and a liquid crystal display device can be provided.

### BRIEF DESCRIPTION OF THE DRAWINGS

FIG. 1 is a configuration view showing a liquid crystal display device 500 in an embodiment according to the invention.

FIG. 2 is a cross-sectional view showing each of optical compensation panels 544R, 544G and 544B in an embodiment according to the invention.

FIGS. 3A, 3B and 3C are each a cross-sectional view showing a manufacturing method of each of optical compensation panels 544R, 544G and 544B successively in an embodiment according to the invention.

FIG. 4 is a graph plotting results of evaluating the Examples and Comparative Examples in an embodiment according to the invention.

FIGS. 5A and 5B are each a view schematically showing the state that separation is generated between respective layers configuring an optical compensation panel.

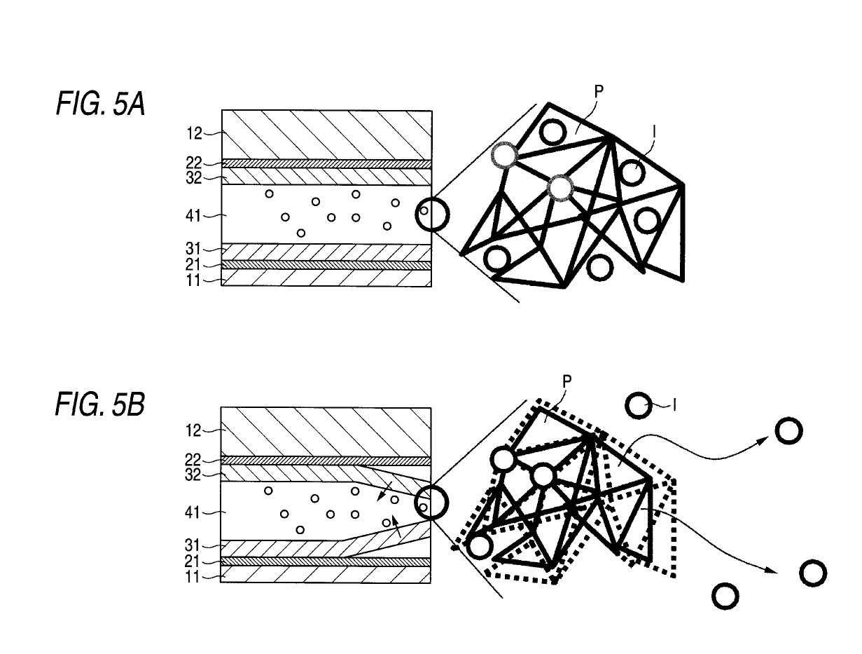

### DETAILED DESCRIPTION OF THE PREFERRED EMBODIMENTS

Embodiments according to the invention is hereunder described.

### (Device Configuration)

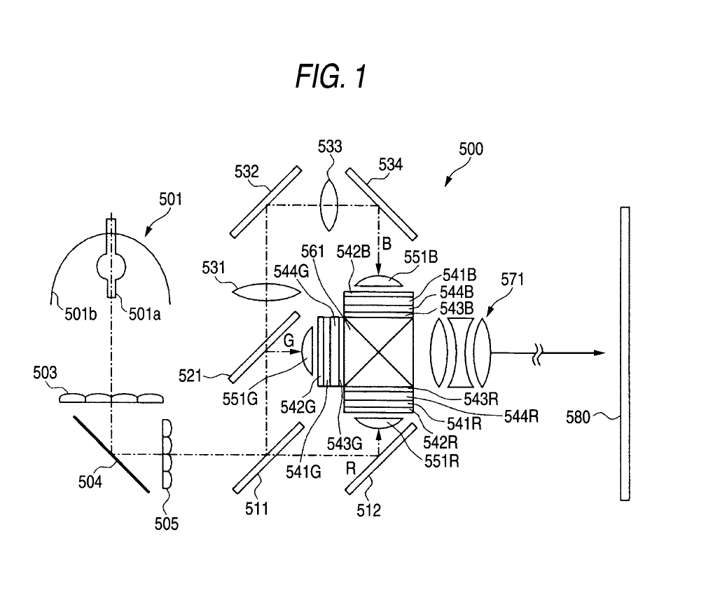

FIG. 1 is a configuration view showing a liquid crystal display device 500 in an embodiment according to the invention.

As shown in FIG. 1, a liquid crystal display device 500 of the present embodiment is of a projection-type liquid crystal display device of a three-plate type and has a light source 501, a first lens array 503, a first reflecting mirror 504, a second lens array 505, a first dichroic mirror 511, a second reflecting mirror 512, a second dichroic mirror 521, a first relay lens 531, a third reflecting mirror 532, a second relay lens 533, a fourth reflecting mirror 534, a first liquid crystal panel 541R, a second liquid crystal panel 541G, a third liquid crystal panel 541B, a first condenser lens 551R, a second condenser lens 551G, a third condenser lens 551B, a dichroic prism 561 and a projection lens unit 571.

The respective parts of the liquid crystal display device 500 of the present embodiment are hereunder described successively.

The light source 501 has a lamp 501a and a reflector 501b. The lamp 501a is, for example, configured by using a metal halide lamp and emits white light in a radial manner. The reflector 501b has a reflecting surface, and this reflecting surface reflects the light from the lamp 501a and emits the light from an opening thereof in parallel to an optical axis.

The first lens array 503 has a configuration in which plural lenses are arranged in a matrix manner and divides the light from the light source 501 into plural light fluxes.

The first reflecting mirror 504 reflects the light which has transmitted through the first lens array 503 and polarizes it toward the second lens array 505.

The second lens array 505 has a configuration the same as in the first lens array 503, in which plural lens are arranged in a matrix manner, and emits the light from the first reflecting mirror 504 into the first dichroic mirror 511.

The first dichroic mirror 511 separates the light from the second lens array 505 such that lights of blue component B and green component G are reflected, whereas light of red component R is transmitted. The transmitted light of red component R is emitted into the second reflecting mirror 512, and the reflected lights of blue component B and green component G are emitted into the second dichroic mirror 521.

The second reflecting mirror 512 reflects and polarizes the light of red component R which has transmitted through the first dichroic mirror 511, thereby making it incident into the first liquid crystal panel 541R via the first condenser lens 551R.

The second dichroic mirror 521 separates the lights of blue component B and green component G which have been reflected by the first dichroic mirror 511 such that the light of blue component B is transmitted, whereas the light of green component G is reflected. The reflected light of green component G is emitted into the second liquid crystal panel 541G via the second condenser lens 551G. On the other hand, the light of blue component B transmits through the first relay lens 531 and is then emitted into the third reflecting mirror 532.

The first relay lens 531 receives the light from the second dichroic mirror 521 and emits it into the third reflecting mirror 532. The first relay lens 531 is provided for the purpose of enhancing the use efficiency of the light of blue component B having a longer optical path length than the lights of other colors.

The third reflecting mirror 532 reflects and polarizes the light of blue component B and emits it into the fourth reflecting mirror 534 via the second relay lens 533.

The second relay lens 533 receives the light from the third reflecting mirror 532 and emits it into the fourth reflecting mirror 534. Similar to the foregoing first relay lens 531, the second relay lens 533 is provided for the purpose of enhancing the use efficiency of the light of blue component B having a longer optical path length than the lights of other colors.

The fourth reflecting mirror 534 reflects and polarizes the light of blue component B from the third reflecting mirror 532 and emits it into the third liquid crystal panel 541B via the third condenser lens 551B.

Each of the first, second and third liquid crystal panels 541R, 541G and 541B is disposed so as to face at the incident surface of the dichroic prism 561.

The first liquid crystal panel 541R is, for example, of an active matrix type and has a TFT substrate (not illustrated), an opposing substrate thereto (not illustrated) and a liquid crystal layer (not illustrated). The first liquid crystal panel 541R receives the light to be irradiated from the light source 501 via the respective parts from the opposing substrate side and then emits it into the TFT substrate side via the liquid crystal layer, thereby displaying an image. Here, as shown in FIG. 1, in the first liquid crystal panel 541R, a pair of polarizing plates 542R and 543R are disposed on surfaces thereof on a light-incident side and a light-outgoing side, respectively under the crossed nicols. On the light-outgoing side, an optical compensation panel 544R is disposed such that it is interposed between the first liquid crystal panel 541R and the polarizing plate 543R. The first liquid crystal panel 541R transmits therethrough the light of red component R which has been made incident via the one-sided polarizing plate 542R from the first condenser lens 551R and emits the transmitted light into the dichroic prism 561 via the optical compensation panel 544R and the other polarizing plate 543R, respectively.

Similar to the first liquid crystal panel 541R, the second liquid crystal panel 541G is of an active matrix type and has a TFT substrate (not illustrated), an opposing substrate thereto (not illustrated) and a liquid crystal layer (not illustrated). The second liquid crystal panel 541G receives the light to be irradiated from the light source 501 via the respective parts from the opposing substrate side and then emits it into the TFT substrate side via the liquid crystal layer, thereby displaying an image. Here, as shown in FIG. 1, in the second liquid crystal panel 541G, a pair of polarizing plates 542G and 543G are disposed on surfaces thereof on a light-incident side and a light-outgoing side, respectively under the crossed nicols. On the light-outgoing side, an optical compensation panel 544G is disposed such that it is interposed between the second liquid crystal panel 541G and the polarizing plate 543G. The second liquid crystal panel 541G transmits therethrough the light of green component G which has been made incident via the one-sided polarizing plate 542G from the second condenser lens 551G and emits the transmitted light into the dichroic prism 561 via the optical compensation panel 544G and the other polarizing plate 543G, respectively.

Similar to the first liquid crystal panel 541R and the second liquid crystal panel 541G, the third liquid crystal panel 541B is of an active matrix type and has a TFT substrate (not illustrated), an opposing substrate thereto (not illustrated) and a liquid crystal layer (not illustrated). The third liquid crystal panel 541B receives the light to be irradiated from the light source 501 via the respective parts from the opposing substrate side and then emits it into the TFT substrate side via the liquid crystal layer, thereby displaying an image. Here, as shown in FIG. 1, in the third liquid crystal panel 541B, a pair of polarizing plates 542B and 543B are disposed on surfaces thereof on a light-incident side and a light-outgoing side, respectively under the crossed nicols. On the light-outgoing side, an optical compensation panel 544B is disposed such that it is interposed between the third liquid crystal panel 541B and the polarizing plate 543B. The third liquid crystal panel 541B transmits therethrough the light of blue component B which has been made incident via the one-sided polarizing plate 542B from the third condenser lens 551B and emits the transmitted light into the dichroic prism 561 via the optical compensation panel 544B and the other polarizing plate 543B, respectively.

The dichroic prism 561 combines the lights of components of respective colors which have transmitted through the first, second and third liquid crystal panels 541R, 541G and 541B to produce a color image and emits the produced color image into the projection lens unit 571.

The projection lens unit 571 enlarges and projects the produced color image by the dichroic prism 561, thereby displaying it on a screen 580.

A detailed structure of each of the optical compensation panels 544R, 544G and 544B is hereunder described.

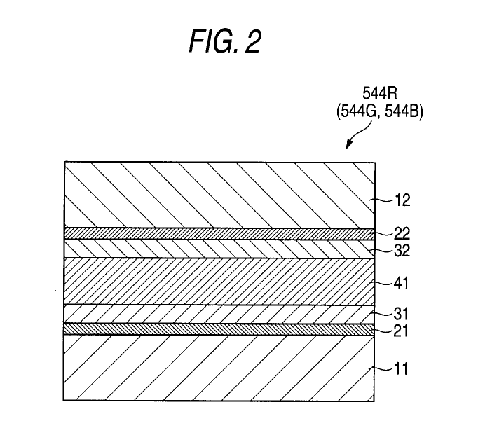

FIG. 2 is a cross-sectional view showing each of optical compensation panels 544R, 544G and 544B in an embodiment according to the invention.

As shown in FIG. 2, each of the optical compensation panels 544R, 544G and 544B has a first protective substrate 11, a second protective substrate 12, a first optical compensation layer 31, a second optical compensation layer 32 and an adhesive layer 41. As shown in FIG. 1, the optical compensation panels 544R, 544G and 544B are disposed so as to face at the surfaces of the liquid crystal panels 541R, 541G and 541B to be irradiated with light in the liquid crystal display device 500, respectively and optically compensate a phase difference generated by each of the liquid crystal panels 541R, 541G and 541B, thereby enhancing the contrast of a displayed image. In the present embodiment, the optical compensation panels 544R, 544G and 544B are formed such that a retardation value of an angle of azimuth in the omnidirection is from 0.001 nm to 30 nm at an angle in the polar angle direction of from about 0 degree to about 20 degrees. This is because by making this retardation value fall within this range, an optical compensation characteristic with respect to the liquid crystal panel is favorable.

Also, the optical compensation panels 544R, 544G and 544B are formed such that a retardation to the normal direction is not more than 80 nm. This is because by making this retardation fall within this range, an optical compensation characteristic with respect to the liquid crystal panel is favorable.

The respective parts of the optical compensation panels 544R, 544G and 544B are hereunder described successively.

As shown in FIG. 2, the first protective substrate 11 is a substrate and is, for example, made of an insulating material capable of transmitting light therethrough. The first protective substrate 11 is, for example, made of glass and protects one surface of each of the liquid crystal panels 541R, 541G and 541B.

As shown in FIG. 2, similar to the first protective substrate 11, the second protective substrate 12 is a substrate and is, for example, made of an insulating material capable of transmitting light therethrough. The second protective substrate 12 is, for example, made of glass and protects the other surface of each of the liquid crystal panels 541R, 541G and 541B. Here, as shown in FIG. 2, the second protective substrate 12 is disposed so as to face at the first protective substrate 11.

As shown in FIG. 2, the first optical compensation layer 31 is formed on a surface of the first protective substrate 11 on a side facing at the second protective substrate 12. The first optical compensation layer 31 is made of a liquid crystal material, and a liquid crystal molecule of the liquid crystal material is oriented by an oriented film 21 such as a polyimide film, which is formed on the surface of the first protective substrate 11 through an orientation treatment, thereby having a prescribed birefringence. Thus, the first optical compensation layer 31 optically compensates a phase difference generated by each of the liquid crystal panels 541R, 541G and 541B. Concretely, the first optical compensation layer 31 is made of an ultraviolet-curable liquid crystal material, and nematic liquid crystals and discotic liquid crystals are favorably used.

As shown in FIG. 2, the second optical compensation layer 32 is formed on a surface of the second protective substrate 12 on a side facing at the first protective substrate 11. Similar to the first optical compensation layer 31, the second optical compensation layer 32 is made of a liquid crystal material, and a liquid crystal molecule of the liquid crystal material is oriented by an oriented film 22 which is formed on the surface of the second protective substrate 12 through an orientation treatment, thereby having a prescribed birefringence. Thus, the second optical compensation layer 32 optically compensates a phase difference generated by each of the liquid crystal panels 541R, 541G and 541B.

As shown in FIG. 2, the adhesive layer 41 bonds the first optical compensation layer 31 and the second optical compensation layer 32 so as to face each other.

In the present embodiment, the adhesive layer 41 is made of a photocurable adhesive material and is formed by photopolymerizing a photopolymerization material by a photopolymerization initiator upon irradiation with light. Here, the photopolymerization initiator is contained in an amount of from 2 to 5% by weight relative to the photopolymerization material in starting the photopolymerization. The adhesive layer 41 is formed so as to have a rate of change in glass transition temperature of the adhesive layer 41 falling within 150% and a rate of change in weight of the adhesive layer 41 falling within 5% before and after an annealing treatment (storing for 200 hours under an atmosphere at 100° C.). Also, it is preferable that before and after the foregoing annealing treatment, a rate of shrinkage is not more than 0.5% and a rate of change in elastic modulus falls within 20%.

Concretely, it is preferable that the adhesive layer 41 is made of an acrylic polymer such as polymethacrylate and polycyanomethacrylate or a urethane based polymer. This is because a polymer adhesive prepared from an acrylic polymer or a urethane based polymer also has a high transmittance, and therefore, it is excellent in optical characteristics such as light transmission and optical isotropy. Besides, epoxy based polymers, polyester elastomers and carbonate based polymers are preferable.

When before and after an annealing treatment (storing for 200 hours under an atmosphere at 100° C.), the rate of change in glass transition temperature of the adhesive layer 41 exceeds 150%, the adhesive layer 41 is cured, and therefore, separation is easily generated. For that reason, in the present embodiment, a material of the adhesive layer 41 is properly selected and used such that before and after an annealing treatment, the rate of change in glass transition temperature of the adhesive layer 41 is not more than 150%. Also, when before and after an annealing treatment (storing for 200 hours under an atmosphere at 100° C.), the rate of change in weight of the adhesive layer 41 exceeds 5%, a change in volume of the adhesive layer 41 is large, and therefore, separation is easily generated. For that reason, in the present embodiment, a material of the adhesive layer 41 is properly selected and used such that before and after an annealing treatment, the rate of change in weight of the adhesive layer 41 falls within 5%.

In the present embodiment, the polymerization initiator is a compound which generates a radical upon irradiation with ultraviolet light. Examples of the polymerization initiator which is favorably used include 2-hydroxy-2-methyl-1-phenylpropan-1-one, hydroxycyclohexyl phenyl ketone, methyl phenyl glyoxylate, benzyl dimethyl ketal, Michler's ketone, 2-benzyl-2-dimethylamino-1-(4-morpholinophenyl)-butanone-1,2-chlorothioxanthone, 2,4-diethylthioxanthone, 2-isopropylthioxanthone, 2,4,6-trimethylbenzoyldiphenyl phosphine oxide and bis(2,6-dimethoxybenzoyl)-2,4,4-trimethylpentyl phosphine oxide. Besides, a photopolymerization initiation aid such as amines can be used jointly. Examples of this photopolymerization initiation aid such as amines, which can be used, include 2-dimethylaminoethyl benzoate, dimethylaminoacetophenone, ethyl p-dimethylaminobenzoate and isoamyl p-dimethylaminobenzoate.

### (Manufacturing Method)

The manufacturing method of each of the foregoing optical compensation panels 544R, 544G and 544B is hereunder described successively.

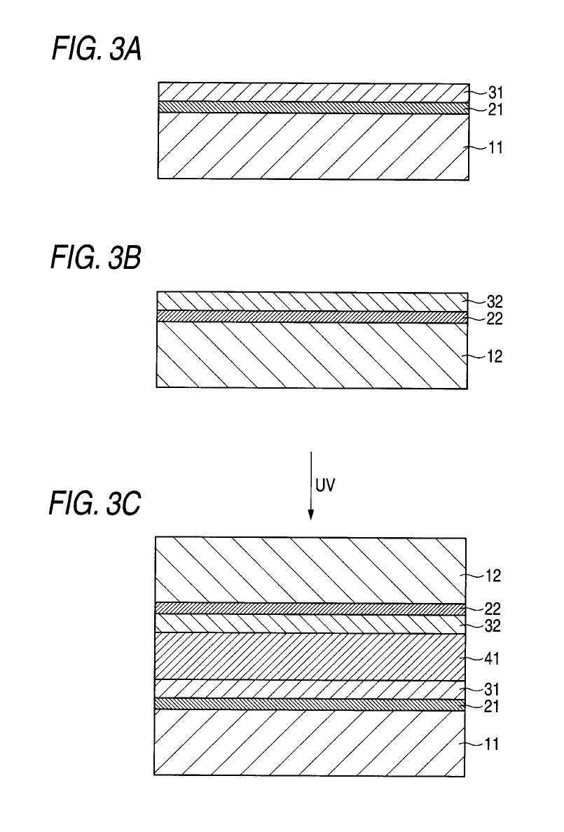

FIGS. 3A, 3B and 3C are each a cross-sectional view showing a manufacturing method of each of the optical compensation panels 544R, 544G and 544B successively in an embodiment according to the invention.

First of all, as shown in FIG. 3A, the first optical compensation layer 31 is formed on the first protective substrate 11.

Here, a polyimide film is coated on one surface of the first protective substrate 11, and the polyimide film is then subjected to an orientation treatment upon irradiation with light, thereby forming the oriented film 21. Thereafter, a photosensitive liquid crystal film composed of an ultraviolet-curable liquid crystal material or the like is coated on the oriented film 21 by, for example, a spin coating method. Then, the photosensitive liquid crystal film is cured upon irradiation with ultraviolet light, thereby forming the first optical compensation layer 31.

Next, as shown in FIG. 3B, the second optical compensation layer 32 is formed on the second protective substrate 12.

Here, a polyimide film is coated on one surface of the second protective substrate 12, and the polyimide film is then subjected to an orientation treatment upon irradiation with light, thereby forming the oriented film 22. Thereafter, a photosensitive liquid crystal film composed of an ultraviolet-curable liquid crystal material or the like is coated on the oriented film 22 by, for example, a spin coating method. Then, the photosensitive liquid crystal film is cured upon irradiation with ultraviolet light, thereby forming the second optical compensation layer 32.

Next, as shown in FIG. 3C, the first optical compensation layer 31 and the optical compensation layer 32 are bonded to each other by the adhesive layer 41.

Here, a coating solution of an adhesive material in which a photopolymerization initiator is contained in an amount of from 2 to 5% by weight relative to a photopolymerization material such as acrylic monomers and urethane based monomers is coated on the surface of the first protective substrate 11 on which the first optical compensation layer 31 is formed.

Furthermore, this adhesive layer 41 is formed so as to have a rate of change in glass transition temperature of the adhesive layer falling within 150% and a rate of change in weight of the adhesive layer falling within 5% before and after an annealing treatment.

Thereafter, the surface of the first protective substrate 11 on which the first optical compensation layer 31 is formed and the surface of the second protective substrate 12 on which the second optical compensation layer 32 is formed are stuck so as to face each other. Then, for example, by irradiating light from the side of the second protective substrate 12, the coating solution of an adhesive material as coated is photopolymerized and cured.

Then, after each of the optical compensation panels 544R, 544G and 544B had been thus manufactured, as shown in FIG. 1, the optical compensation panels 544R, 544G and 544B are bonded to the liquid crystal panels 541R, 541G and 541B, respectively so as to face each other.

### EXAMPLES

Examples according to an embodiment of the invention are hereunder described.

### Example 1

In Example 1, in order to form each of the optical compensation panels 544R, 544G and 544B as shown in FIG. 2, first of all, the oriented film 21 was formed on one surface of the first protective substrate 11. Here, the oriented film 21 was formed by using a polyimide.

Next, the first optical compensation layer 31 was formed. Here, the first optical compensation layer 31 was formed by using a liquid crystal polymer.

Then, the second optical compensation layer 32 was formed in the same manner as in the first optical compensation layer 31.

Next, the first optical compensation layer 31 and the second optical compensation layer 32 were bonded to each other by the adhesive layer 41. Here, the adhesive layer 41 was formed by coating with a coating solution containing a monomer component and a polymerization initiator in a proportion of 2 wt % relative to the weight of the monomer component, and the first optical compensation layer 31 and the second optical compensation layer 32 were bonded to each other by the adhesive layer 41. Here, three monomers of an acrylic monomer A, an acrylic monomer B and a urethane based monomer C were used as the monomer component, and two kinds of a photopolymerization initiator A and a photopolymerization initiator B were used as the polymerization initiator. Also, in this Example 1, two samples were prepared.

### Example 2

Different from Example 1, in Example 2, a coating solution containing a monomer component and a polymerization initiator in a proportion of 3 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Example 2 is identical with Example 1, except for this point.

### Example 3

Different from Example 1, in Example 3, a coating solution containing a monomer component and a polymerization initiator in a proportion of 4 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Example 3 is identical with Example 1, except for this point.

### Example 4

Different from Example 1, in Example 4, a coating solution containing a monomer component and a polymerization initiator in a proportion of 5 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Example 4 is identical with Example 1, except for this point.

### Comparative Example 1

Different from Example 1, in Comparative Example 1, a coating solution containing a monomer component and a polymerization initiator in a proportion of 1 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Comparative Example 1 is identical with Example 1, except for this point.

### Comparative Example 2

Different from Example 1, in Comparative Example 2, a coating solution containing a monomer component and a polymerization initiator in a proportion of 6 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Comparative Example 2 is identical with Example 1, except for this point.

### Comparative Example 3

Different from Example 1, in Comparative Example 3, a coating solution containing a monomer component and a polymerization initiator in a proportion of 7 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Comparative Example 3 is identical with Example 1, except for this point.

### Comparative Example 4

Different from Example 1, in Comparative Example 4, a coating solution containing a monomer component and a polymerization initiator in a proportion of 8 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Comparative Example 4 is identical with Example 1, except for this point.

### Comparative Example 5

Different from Example 1, in Comparative Example 5, a coating solution containing a monomer component and a polymerization initiator in a proportion of 10 wt % relative to the weight of the monomer component was prepared. Then, the adhesive layer 41 was formed by coating this coating solution in the same manner as in Example 1, and the first optical compensation layer 31 and the second optical compensation layer 32 were bonded to each other. This Comparative Example 5 is identical with Example 1, except for this point.

Evaluation results regarding the foregoing Examples and Comparative Examples are hereunder described.

Table 1 shows the results obtained by evaluating the Examples and Comparative Examples according to an embodiment of the invention.

As shown in Table 1, (1) rate of change in glass transition temperature, (2) rate of change in weight and (3) separation state were measured.

With respect to the “rate of change in glass transition temperature”, a glass transition point of the adhesive layer 41 was measured by the DMA method with respect to each of the foregoing optical compensation panels before and after an annealing treatment (storing for 200 hours under an atmosphere at 100° C.) . Here, the glass transition temperature was measured by setting up a sample size at 5 mm×5 mm×1 mm in thickness and regulating a temperature rise rate at 5° C./min. As shown in Table 1, with respect to each of the samples in which the adhesive layer 41 was formed at a glass transition temperature before the annealing treatment at from 36° C. to 43° C., a glass transition temperature after the annealing treatment was measured. By dividing the glass transition temperature of the adhesive layer 41 after the annealing treatment by the glass transition temperature of the adhesive layer 41 before the annealing treatment, a rate of change in glass transition temperature was calculated in terms of a percentage.

Also, with respect to the “rate of change in weight”, a weight of each of the foregoing optical compensation panels was measured before and after an annealing treatment by using an electronic force balance. Here, the sample size was set up at 70 mm×10 mm×1 mm in thickness. A value obtained by differentiating 100 from a percentage value as calculated by dividing a weight of the adhesive layer 41 after an annealing treatment (storing for 200 hours under an atmosphere at 100° C.) by a weight of the adhesive layer 41 before the annealing treatment was calculated as a rate of change in weight.

Also, with respect to the “separation state”, whether separation of the adhesive layer 41 was generated (designated as “yes”) or not generated (designated as “no”) was judged through observation by a polarizing microscope. Here, with respect to the case where a panel was prepared and annealed under the same condition as in the measurement of physical properties, the observation and judgment were carried out.

TABLE 1

| | | Glass | Glass | Rate of change | | |
|---|---|---|---|---|---|---|
| | Addition | transition | transition | in glass | Rate of | |
| | amount of | point before | point after | transition | change in | |
| | polymerization | annealing | annealing | point | weight | Separation |
| | initiator | (° C.) | (° C.) | (%) | (%) | state |
| Example 1 | 2 wt % | 42 & 36 | 51 & 44 | 121 & 122 | 2 & 3 | No |
| Example 2 | 3 wt % | 41 | 46 | 112 | 3.11 | No |
| Example 3 | 4 wt % | 39 | 49 | 126 | 3.15 | No |
| Example 4 | 5 wt % | 43 | 47 | 110 | 5 | No |
| Comparative Example 1 | 1 wt % | 41 | 89 | 217 | 2 | Yes |
| Comparative Example 2 | 6 wt % | 39 | 45 | 115 | 6 | Yes |
| Comparative Example 3 | 7 wt % | 42 | 48 | 115 | 7 | Yes |
| Comparative Example 4 | 8 wt % | 40 | 45 | 113 | 8 | Yes |
| Comparative Example 5 | 10 wt % | 43 | 48 | 112 | 10 | Yes |

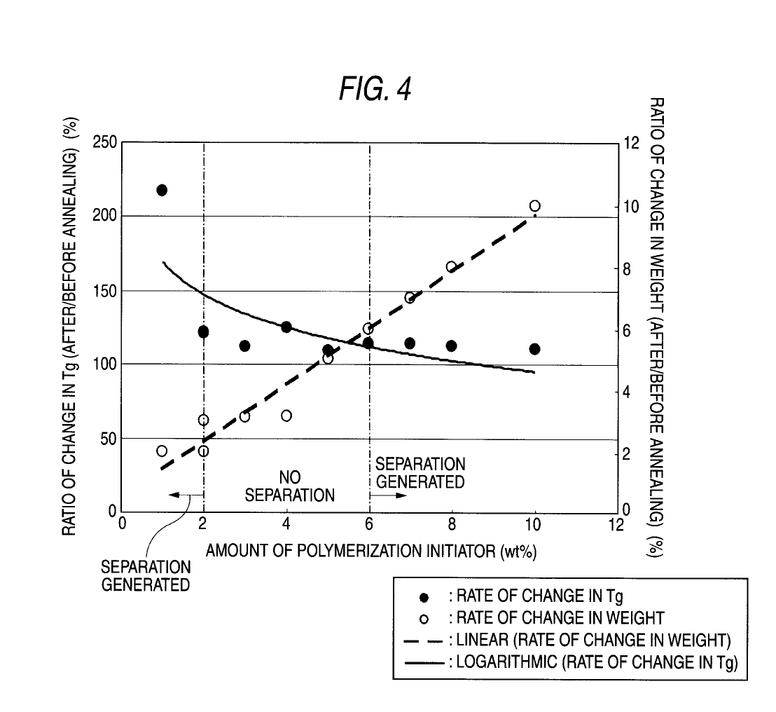

FIG. 4 is a graph plotting results of evaluating the Examples and Comparative Examples in an embodiment according to the invention. In FIG. 4, the results obtained by plotting the measured “rate of change in glass transition temperature” and “rate of change in weight” versus each amount of polymerization initiator (wt %) are shown in terms of a graph.

As shown in FIG. 4, when the amount of polymerization initiator (wt %) is from 2 to 5%, since separation is not generated in an optical compensation panel, the optical compensation can be sufficiently realized in Examples 1, 2, 3 and 4. Accordingly, not only an image with high contrast can be displayed, but the image quality can be enhanced.

On the other hand, as shown in FIG. 4, when the amount of polymerization initiator (wt %) is less than 2%, the “rate of change in glass transition temperature” is large, and separation is generated. It is thought that when the amount of polymerization initiator (wt %) is low, since a large amount of an uncured portion of the adhesive remains, an adhesive force cannot be kept, whereby separation is generated.

Also, as shown in FIG. 4, when the amount of polymerization initiator (wt %) exceeds 5%, the “rate of change in weight” is large, and separation is generated. It is thought that when the amount of polymerization initiator (wt %) is high, since vaporization of the polymerization initiator is large, the “rate of change in weight” is large and the change in volume is remarkably generated, whereby separation is generated.

Furthermore, as shown in FIG. 4, with respect to the “rate of change in glass transition temperature (%)”, when it is preferably not more than 150%, and more preferably not more than 130%, the generation of separation can be suppressed. It is thought that when the “rate of change in glass transition temperature (%)” exceeds 150%, since a large amount of an uncured portion of the adhesive remains, an adhesive force cannot be kept, whereby separation is generated. On the other hand, a lower limit value of the “rate of change in glass transition temperature (%)” may be 100% or more because when the glass transition temperature does not change before and after annealing, it is possible to stably keep an adhesive characteristic. However, even if the “rate of change in glass transition temperature (%)” falls within this range, when the amount of polymerization initiator (wt %) exceeds 5%, as shown in FIG. 4, separation is generated due to the foregoing phenomenon.

In the light of the above, in this embodiment according to the invention, when the adhesive layer 41 is formed, the photopolymerization initiator is contained in an amount of from 2 to 5% by weight relative to the photopolymerization material in starting the photopolymerization. Also, this adhesive layer 41 is formed so as to have a rate of change in glass transition temperature of the adhesive layer falling within 150% and a rate of change in weight of the adhesive layer falling within 5% before and after an annealing treatment.

For that reason, in this embodiment according to the invention, the generation of layer-to-layer separation can be prevented from occurring due to the matter that the polymerization initiator of the adhesive layer 41 is vaporized under a high-temperature atmosphere, whereby the weight and volume of the adhesive layer 41 decrease. Accordingly, in this embodiment, since the optical compensation panels 544R, 544G and 544B are able to sufficiently realize optical compensation, not only an image with high contrast can be displayed, but the image quality can be enhanced.

In carrying out the invention, the invention is not limited to the foregoing embodiment, but various modified embodiments can be employed.

For example, while the projection type liquid crystal display device of a three-plate type has been described in the foregoing embodiment, it should not be construed that the invention is limited thereto. The invention can also be applied to, for example, a projection type liquid crystal display device of a single-plate type.

Also, for example, a substrate in which a pixel switching element such as TFT is formed may be used as the substrate which configures an optical compensation panel.

It should be understood by those skilled in the art that various modifications, combinations, sub-combinations and alternations may occur depending on design requirements and other factors insofar as they are within the scope of the appended claims or the equivalents thereof.

What is claimed is:

1. An optical compensation panel comprising
a first optical compensation layer,
a second optical compensation layer, and
an adhesive layer for bonding the first optical compensation layer and the second optical compensation layer so as to face each other, wherein
the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and
the adhesive layer is formed so as to have a rate of change in glass transition temperature of the adhesive layer falling within 150% and a rate of change in weight of the adhesive layer falling within 5% before and after an annealing treatment.

2. The optical compensation panel according to claim 1, wherein
the adhesive layer contains at least one of an acrylic polymer and a urethane based polymer.

3. The optical compensation panel according to claim 1, wherein
the first optical compensation layer and the second optical compensation layer are disposed on a surface of a liquid crystal panel to be irradiated with light in a liquid crystal display device so as to face each other.

4. The optical compensation panel according to claim 3, wherein
the liquid crystal display device is of a projection type.

5. A method for manufacturing an optical compensation panel comprising the step of:
bonding a first optical compensation layer and a second optical compensation layer by an adhesive layer so as to face each other, wherein
the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and the adhesive layer is formed so as to have a rate of change in glass transition temperature of the adhesive layer falling within 150% and a rate of change in weight of the adhesive layer falling within 5% before and after an annealing treatment.

6. A liquid crystal display device comprising:
a liquid crystal panel having optical compensation panels d;pisposed on a surface thereof to be irradiated with light so as to face each other, wherein the optical compensation panel has a first optical compensation layer,
a second optical compensation layer, and
an adhesive layer for bonding the first optical compensation layer and the second optical compensation layer so as to face each other; and
the adhesive layer is made of a photopolymerization material, photopolymerization of which is started by a photopolymerization initiator upon irradiation with light, with the photopolymerization initiator being contained in an amount of from 2 to 5% by weight relative to the photopolymerization material in starting the photopolymerization, and
the adhesive layer is formed so as to have a rate of change in glass transition temperature of the adhesive layer falling within 150% and a rate of change in weight of the adhesive layer falling within 5% before and after an annealing treatment.
